(19) United States
(12) Patent Application Publication
(10) Pub. No.: US 2012/0121360 A1
(43) Pub. Date: May 17, 2012

(54) Fastening Device and Fastening System

(75) Inventors: Christoph KARL, Zell am Harmbersbach (DE); Klaus Ehrler, Niederstetten (DE)

(73) Assignee: Neumayer Tekfor Holding GmbH, Hausach (DE)

(21) Appl. No.: 13/355,993

(22) Filed: Jan. 23, 2012

Related U.S. Application Data
(63) Continuation of application No. PCT/DE2010/000833, filed on Jul. 16, 2010.

(30) Foreign Application Priority Data
Jul. 24, 2009 (DE) 10 2009 034 665.1

(51) Int. Cl. F16B 37/04

(52) U.S. Cl. 411/172

(57) ABSTRACT

A fastening device including at least one nut and at least one holding element, in which the at least one nut and the at least one holding element functionally engage each other, and a fastening system including such a fastening device.

### CROSS REFERENCE TO RELATED APPLICATIONS

This application is a continuation of international patent application no. PCT/DE2010/000833, filed Jul. 16, 2010 designating the United States of America and published in German on Jan. 27, 2011 as WO 2011/009440, the entire disclosure of which is incorporated herein by reference. Priority is claimed based on Federal Republic of Germany patent application no. DE 10 2009 034 665.1, filed Jul. 24, 2009, the entire disclosure of which is likewise incorporated herein by reference.

### BACKGROUND OF THE INVENTION

The present invention relates to a fastening device. In addition, the invention relates to a fastening system.

The prior art includes the teaching of connecting construction elements to each other via nuts, wherein the nuts are rotated onto bolts or screws. Most commonly, the construction elements or components being connected to each other are brought into contact with each other, and then the nut is placed on a bolt or a screw and tightened. Depending on the design of the elements, this process can involve difficulties. In addition, the nut is an additional construction component which requires separate attention.

### SUMMARY OF THE INVENTION

The invention addresses the problem of simplifying the way nuts are used. This problem is addressed by the invention by providing a new fastening device and a new fastening system.

In accordance with the invention, the problem is solved by the fastening device in that the fastening device has at least one nut which in turn has a longitudinal axis and at least one bore hole which is oriented substantially along the longitudinal axis, and has at least one holding element. The at least one nut and the at least one holding element are functionally engaged with each other. The holding element preferably serves to hold or to fix the nut onto a bolt or onto an element, and/or onto a construction component such as a tube or a section of a shaft. The holding element and nut are in contact with each other, and preferably connected to each other in a manner which prevents loss.

In one embodiment of the fastening device according to the invention, the nut has an internal threading inside the bore hole, at least in a section or sections thereof.

In another embodiment of the fastening device according to the invention, the bore hole of the nut is constructed as a hole which passes through the nut entirely, or as a blind bore hole.

In a further embodiment of the fastening device according to the invention, the holding element is constructed to be elastically deformable, at least in a section or sections thereof.

In yet another embodiment of the fastening device according to the invention, the holding element is constructed to be plastically deformable, at least in a section or sections thereof. As such, the holding element is pressed or fitted into place onto, by way of example, a construction component or onto the corresponding geometry by plastic deformation. This simplifies the manufacture thereof, and enables adaptation of the nut to any type of geometry presented by the construction components connected to each other by the fastening device.

In a still further embodiment of the fastening device according to the invention, the holding element is constructed with a spring function, at least in a section or sections thereof. This facilitates, by way of example, the application of the holding element onto, and the holding function of the holding element on, a construction component.

In an additional embodiment of the fastening device according to the invention, the holding element has a bend which projects toward the longitudinal axis of the nut, at least in a section or sections thereof. The holding element has a bend, for example toward the construction component or a section thereof, wherein said holding element is rotated about and onto the construction component. This means that by sliding or rotating the holding element onto the construction component, the holding element exerts a force in the direction of the, for example, longitudinal axis of the component or a section thereof.

In another embodiment of the fastening device according to the invention, the bend of the holding element is situated at least on one end region thereof which lies opposite the end of the nut, and the bend projects toward the longitudinal axis of the nut. As is indicated in embodiments described below, the end region which lies opposite the nut is, by way of example, additionally or as an alternative constructed with a hook shape, at least sectionally.

In still another embodiment of the fastening device according to the invention, the holding element has a bend which angles away from the longitudinal axis of the nut, at least in a section or sections thereof. In the case of one simple design thereof, a simple holding element then also exerts a force which is applied inward. This and also other embodiments refer to situations where the holding element is placed onto the construction component and/or a section thereof.

In an additional embodiment of the fastening device according to the invention, the holding element itself, at least on one end region thereof which lies opposite the end of the nut, is angled away from the longitudinal axis of the nut. This also functions to lock the holding element in place on the construction component.

In one embodiment of the fastening device according to the invention, the holding element is angled, with at least one end region thereof which faces toward the nut, toward the longitudinal axis of the nut. In contrast to the previous embodiment, the holding element is therefore curved toward the nut on the end region thereof which lies opposite the nut, and is, by way of example, locked into place, crimped, or otherwise attached. Therefore, for the purpose of the connection between the nut and the holding element, the nut can comprise, with one segment, the end region of the holding element which lies opposite the nut, or this end region can comprise a region of the nut, depending on the embodiment.

In another embodiment of the fastening device according to the invention, the end region of the at least one holding element which lies opposite the nut is constructed with a hook shape, at least sectionally. Such a hook serves to fix the holding element on the construction component and/or the corresponding element.

In a further embodiment of the fastening device according to the invention, the at least one holding element has at least one angled bend which leads particularly in the direction of the nut longitudinal axis. Such an angled bend can, by way of example, lock into a corresponding nut or a recess of the construction component. Such an angled bend therefore differs from, for example, a hook constructed on the end region of the holding element, because the holding element then continues its extension from the angled bend to the end region.

In yet another embodiment of the fastening device according to the invention, the nut is made of metal or of a plastic material, at least sectionally.

In a still further embodiment of the fastening device according to the invention, the holding element is made of sheet metal, at least sectionally.

In still another embodiment of the fastening device according to the invention, the holding element is made of a plastic material, at least sectionally. At the same time, the nut can be made of a plastic material, at least sectionally.

In one embodiment of the fastening device according to the invention, the holding element and the nuts are constructed as one single integral part. As such, the fastening device in this embodiment is not constructed of multiple parts, or of at least two parts. In this embodiment, the holding element and the nut are preferably made of the same material. However, in the multi-part variants, the same or different materials can also be used.

In another embodiment, the nut and the holding element are constructed in such a manner and are connected to each other such that the holding element and the nut can be rotated relative to each other. The holding element and the nut can preferably be rotated toward each other about the longitudinal axis of the nut. This enables the nut to be attached onto a counter piece, even after the nut is fixed via the holding element, without, by way of example, scratching the surface of a construction component.

In a further embodiment of the fastening device according to the invention, at least two holding elements are included. As such, multiple holding elements are included. In one embodiment, the holding elements are either entirely or at least sectionally constructed with a tongue shape, and are distributed radially about the bore hole periphery of the nut. In another embodiment, the holding elements overlap each other at least sectionally. In a further embodiment, the holding elements are sections of a substantially cage-like element, and have, by way of example, a tongue shape.

In yet another embodiment of the fastening device according to the invention, the at least two holding elements are distributed substantially evenly about the periphery of the bore hole of the nut.

In a still further embodiment of the fastening device according to the invention, the at least two holding elements are distributed about the periphery of the bore hole of the nut in a cage-like manner. As such, said holding elements as a whole form a holding cage.

In addition, the problem is solved by the fastening system according to the present invention in that the fastening system comprises at least one fastening device according to one of the previous embodiments, and at least one element, wherein the element has at least one recess, wherein the element and the holding element are constructed in such a manner and are adapted or matched to each other such that the holding element can engage functionally with the element via the recess. As such, the fastening device is attached and/or fixed on the element via the holding element. In one embodiment, the hooks of the holding elements are therefore intended to fit into the recess, generating sufficient force to hold the element. In this way, the nut is attached to the element. This attachment can preferably be reversed.

In one embodiment of the fastening system according to the invention, the recess is a groove which runs around the periphery. As such, the element is preferably constructed as rotationally symmetrical, at least in the region thereof into which the fastening device is placed.

In another embodiment of the fastening system according to the invention, the element is constructed as a cylinder, at least in a section or sections thereof.

In a further embodiment of the fastening system according to the invention, the element is a tube or a shaft, at least in a section or sections thereof.

In yet another embodiment of the fastening system according to the invention, the holding element and the element are constructed in such a manner and are adapted to each other such that the holding element can be slid onto the element in one direction, and the holding element exerts at least one force onto the element to oppose a movement against said one direction after the holding element has been slid onto the element. As such, the holding element prevents, by way of example, the nut from falling off or being pulled off the element.

In a still further embodiment of the fastening system according to the invention, at least one counter piece to the element is included, and the nut and the counter piece are constructed in such a manner and are adapted to each other such that the counter piece can be inserted into the bore hole of the nut. As such, when the element and the counter piece are assembled, in one embodiment the fastening device is initially connected to the element via the holding element, wherein the holding element is, by way of example, slid onto the element until the holding element locks into the recess of the element. In this way, the nut becomes fixed with respect to the element. Next, the counter piece is inserted into the bore hole of the nut and screwed into the nut. As such, in one embodiment, the counter piece can be inserted into the element sectionally. In addition, by tightening the nut, the one element can be moved relative to the other element by the holding element such that one component is tightened against its counter component. In this case, tensioning optionally occurs against an axial limit stop.

### BRIEF DESCRIPTION OF THE DRAWINGS

The invention will be described in further detail hereinafter with reference to illustrative embodiments shown in the accompanying drawing figures, in which:

FIG. 1 is a three-dimensional perspective illustration of a fastening device according to the invention;

FIG. 2 is a longitudinal sectional view through the fastening device of FIG. 1;

FIG. 3 is a longitudinal sectional view through an alternative embodiment which is a variant of the embodiment shown in FIG. 2;

FIG. 4 is a three-dimensional perspective view of the connection of an element to a counter piece via a fastening device according to the invention;

FIGS. 5 and 6 are sectional views showing the connection of FIG. 4 in two positions thereof;

FIGS. 7a) through 7d) are sectional views showing different embodiments of the end region of the holding element, and

FIGS. 8 a) and b) show further embodiments of the end region of the holding element.

### DETAILED DESCRIPTION OF ILLUSTRATIVE EMBODIMENTS

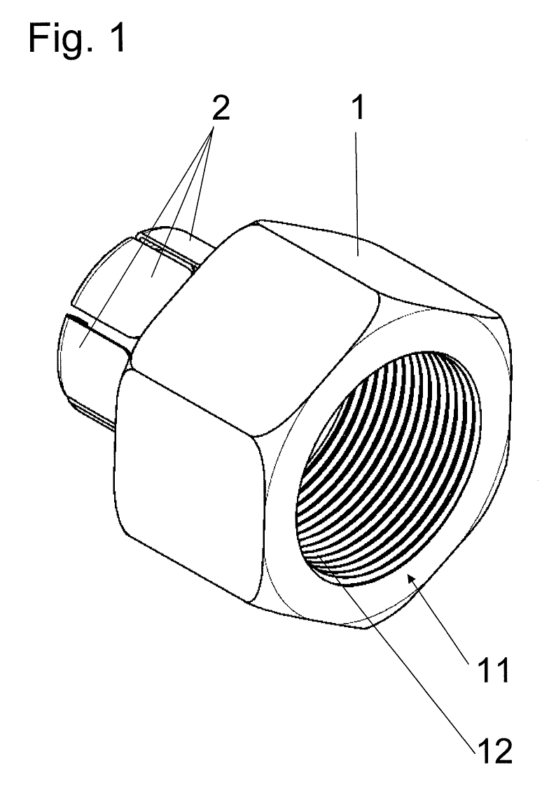

FIG. 1 shows a fastening device according to the invention. The device is comprised of the nut 1 and the tongue-shaped holding elements 2, wherein the holding elements converge in a common foot which extends radially about the nut 1. The nut 1 in this case has a bore hole 11 which passes completely through the nut 1, and the bore hole 11 has an inner threading 12. In addition, the outer side of the nut 1 is constructed in such a manner that it provides contact surfaces for tightening the nut 1. The holding element 2 in this case is constructed in such a manner that it can preferably generate a force which is applied at least radially.

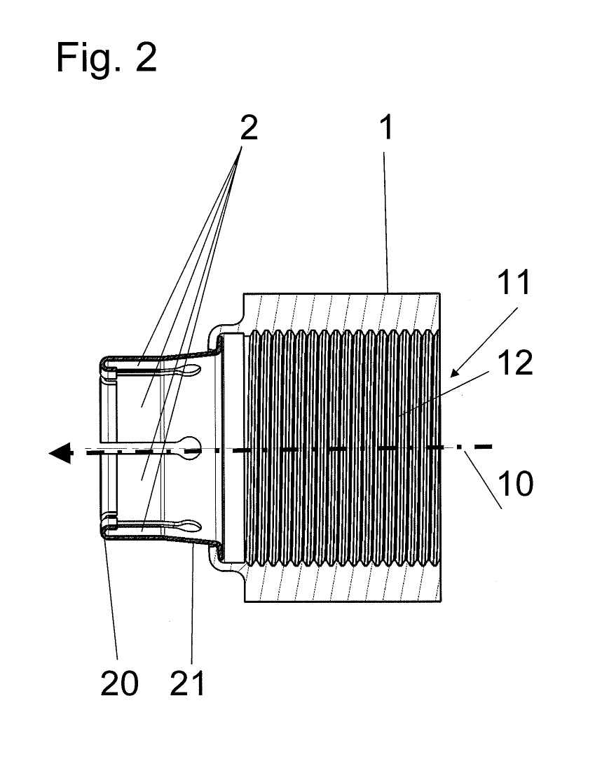

The section through the fastening device of FIG. 1, shown in FIG. 2, shows that the holding element 2 is constructed with a tongue shape. The holding element is made of sections of sheet metal, and a space is found between each of the sections. The holding elements 2 in this case are substantially evenly distributed about the longitudinal axis 10 of the nut 1. The end region 21 of the holding element 2 which faces the nut 1 converges in a common surface which is bent outward, and an end region of the nut 1 is crimped around said surface. Other methods of attaching the holding element and the nut are, by way of example, clipping, gluing, soldering, or welding. The bore hole 11, which extends entirely through the nut 1 and has an inner threading 12, for example, is produced inside the nut 1. Then the holding element 2 or the corresponding holding elements 2 are attached on an end region around the bore hole 11. The end region 21 is angled away from the longitudinal axis 10 and therefore faces outward. The end regions 20 of the holding element 2 which face away from the nut 1 are provided in this case with hooks. The holding elements 2 are, in addition, constructed to function as springs. In total, the holding elements 2 form a holding cage which connects to the nut 1 and which preferably is connected thereto in such a manner that it cannot be lost. The holding element 2 enables the nut 1 to be attached to an element. This can also happen, for example, without the nut 1 engaging functionally with a construction component, meaning before a construction component—in this case having a corresponding outer threading—is inserted into the bore hole 11. In other words, the nut 1 is already attached before anything is contained in the bore hole 11.

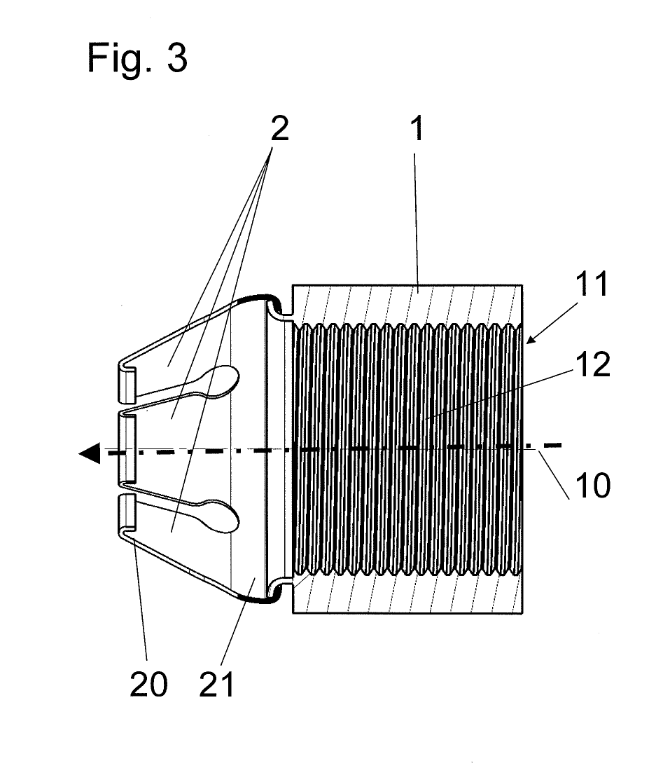

In FIG. 3, the holding elements 2 are situated outside the projection of the nut 1 and therefore contain the nut. In the illustrative embodiment shown here, the region 20 lying opposite the nut narrows more strongly inward than in the embodiments shown in FIG. 1 or in FIG. 2.

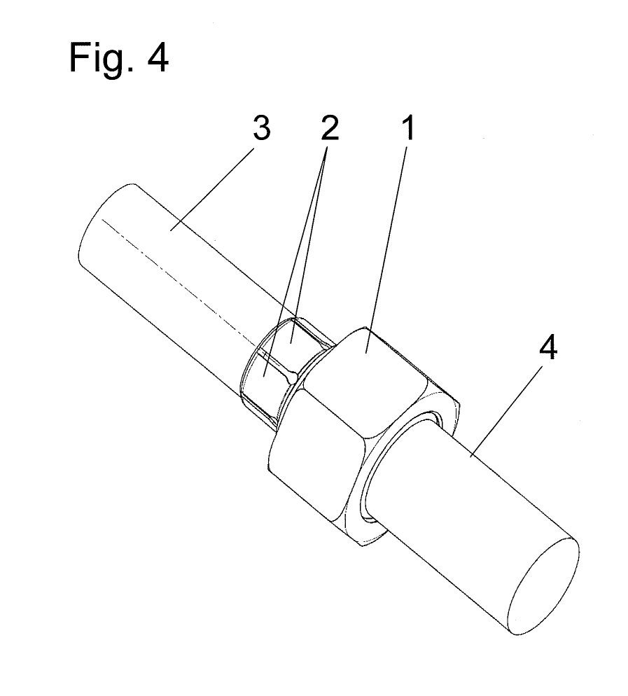

FIG. 4 illustrates how the fastening device connects an element 3 to a counter piece 4. The method in this case has the following steps in one variant: the fastening device is slid onto the element 3 until the holding element 2 locks into a recess. As such, the nut 1 becomes axially fixed with respect to the element 3. Next, the counter piece 4 is inserted into the bore hole 11 of the nut 1, and the nut 1 can be rotated. This can be performed without damaging the surface of the element 3 because the holding element 2 and the nut 1 are particularly constructed to be able to rotate relative to each other. In this case, two construction components in particular are connected. These components can be shafts or axles, by way of example, wherein one has an outer threading and the other has a groove in the outer surface.

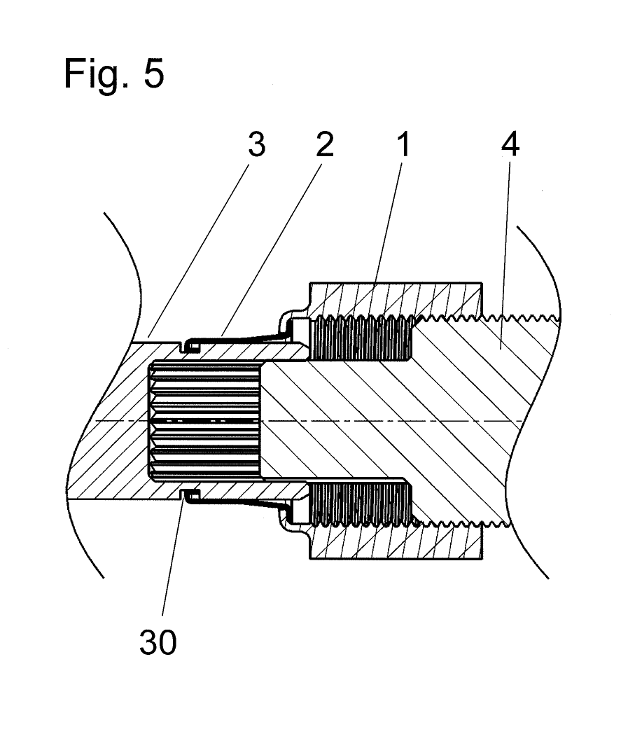

FIG. 5 shows a step in the production of such a connection. The counter piece 4 and the element 3 in this case are constructed in such a manner that the counter piece 4 or a section thereof is inserted into the element 3. The splining in this case ensures that the connection is secure against rotation. The configuration shows how the hook-shaped end regions of the holding element 2 are locked into the recess 30 of the element 3, the recess being constructed in this case as a groove running around the periphery. The configuration therefore prevents the nut 1 from being pulled off the element 3 unintentionally. As such, the element 3 can be equipped in advance with a nut 1, for example.

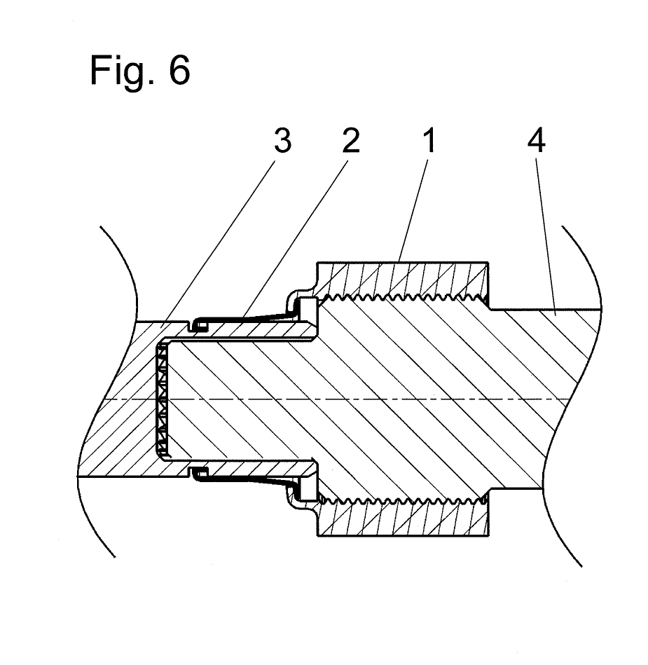

In FIG. 6, the outer threading of the counter piece 4 is screwed into the inner threading of the nut 1, and the element 3 and the counter piece 4 are therefore connected to each other. In one variant, the nut 1 is initially attached to the counter piece 4. Next, the holding element 2 is slid over the element 2, and the connection is realized by tightening the nut 1 against an axial limit stop. As a result of the torque-proof connection between the element 3 and the counter piece 4, tightening of the nut 1 in connection with the holding element 2 functions to draw the element 3 and the counter piece 4 to each other up to a corresponding stop.

In a further embodiment, the holding element 2 is constructed in such a manner that it also limits a movement toward the element 3. The holding elements 2 therefore function, by way of example, to support the crash behavior of steering columns, drive shafts, or gear shafts in automobiles. As such, the invention can also be used to realize a protective device which protects against axial overload in shaft connections in vehicles. In addition, it is possible to connect shafts or tubes or any other element having the same or different diameters or outside geometries to each other. On the other hand, the fastening device can also serve the purpose of pull protection, for example for electrical cables, if the holding element functions to oppose a pulling motion. In general, the invention provides a quick assembly system for, by way of example, conduits, staircases, or furniture/shelving.

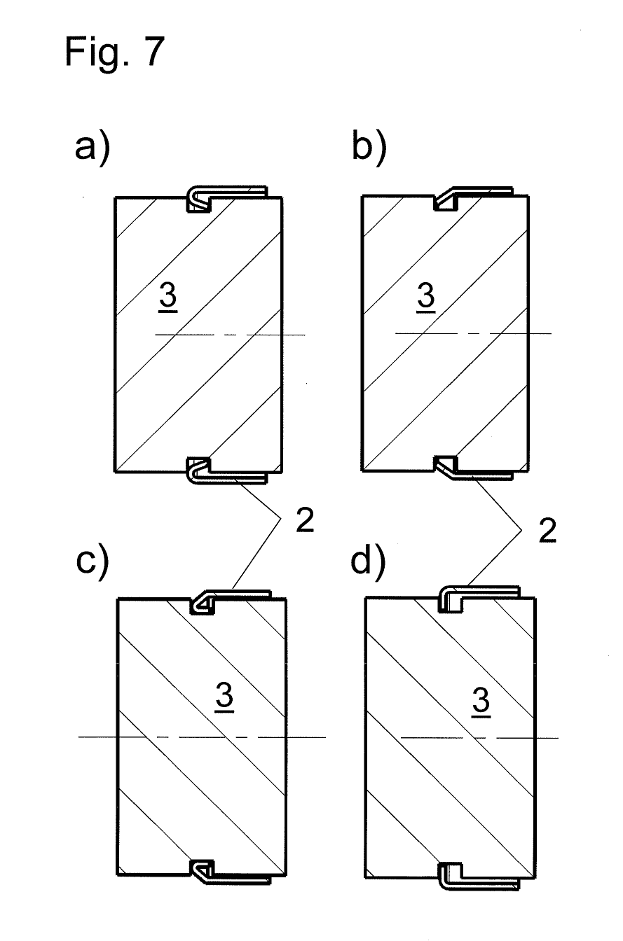

FIGS. 7a) through 7d) show different hook shapes of the end regions of the holding elements 2. These each lock into the recess of the element 3 and provide different spring forces and locking behaviors.

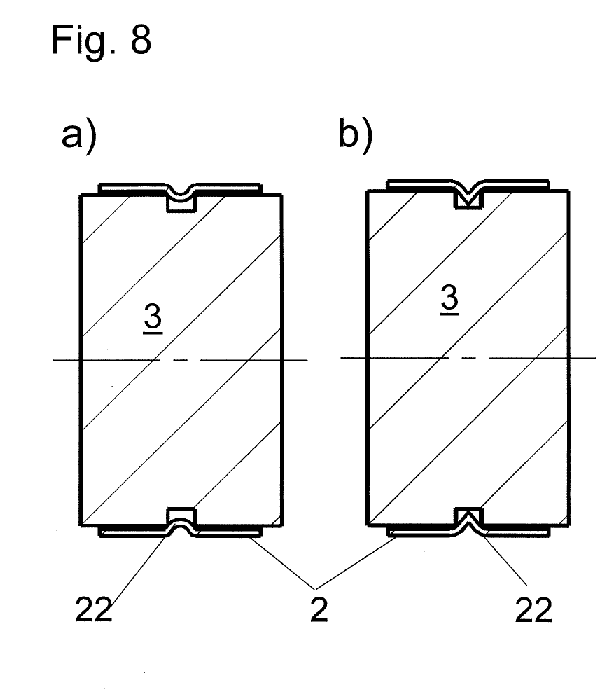

FIG. 8 shows two variants of the angled bend 22 of the holding element 2, both of which likewise engage in recesses of the element 3. In this variant, the holding elements 2 can deform plastically when the holding elements 2 are pressed onto the outer contour of the element 3 during the attachment of the fastening device.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A fastening device comprising:
at least one nut which has a longitudinal axis and at least one bore hole which is oriented substantially along the longitudinal axis, and
at least one holding element,
wherein the at least one nut and the at least one holding element functionally engage each other.

2. A fastening device according to claim 1, wherein the holding element is constructed to be elastically deformable, at least in a section or sections thereof.

3. A fastening device according to claim 1, wherein the holding element is constructed to be plastically deformable, at least in a section or sections thereof.

4. A fastening device according to claim 1, wherein the holding element is constructed with a spring function, at least in a section or sections thereof.

5. A fastening device according to claim 1, wherein the holding element has a bend which projects toward the longitudinal axis of the nut, at least in a section or sections thereof.

6. A fastening device according to claim 1, wherein the holding element has a bend which projects away from the longitudinal axis of the nut, at least in a section or sections thereof.

7. A fastening device according to claim 1, wherein the end region of the at least one holding element which lies opposite the nut is constructed with a hook shape, at least in a section or sections thereof.

8. A fastening device according to claim 1, wherein the at least one holding element has at least one angled bend which leads in the direction of the nut longitudinal axis.

9. A fastening device according claim 1, wherein the nut and the holding element are constructed in such a manner and connected to each other such that the holding element and the nut can be rotated relative to each other.

10. A fastening device according to claim 1, wherein said device comprises at least two holding elements.

11. A fastening device according to claim 10, wherein the at least two holding elements are distributed substantially evenly about the periphery of the bore hole of the nut.

12. A fastening device according to claim 10, wherein the at least two holding elements are distributed about the periphery of the bore hole of the nut in a cage-like manner.

13. A fastening system comprising:
at least one fastening device according to claim 1, and
at least one element having at least one recess;
wherein said element having at least one recess and the holding element of the fastening device are constructed in such a manner and adapted to each other such that the holding element of the fastening device can engage functionally with said element having at least one recess via the at least one recess of said element.

14. A fastening system according to claim 13, wherein the recess is a groove which extends around the periphery of the element having at least one recess.

15. A fastening system according to claim 13, wherein the element having at least one recess is constructed as a cylinder, at least in a section or sections thereof.

16. A fastening system according to claim 13, wherein:
the holding element of the fastening device and the element having at least one recess are constructed in such a manner and are adapted to each other such that the holding element can be slid onto the element having at least one recess in one direction, and
the holding element of the fastening device exerts a force on the element having at least one recess to oppose any movement counter to said one direction after the holding element of the fastening device has been slid onto the element having at least one recess.

17. A fastening system according to claim 13, further comprising at least one counter piece to the element having at least one recess, and
wherein the nut of the fastening device and the counter piece are constructed in such a manner and adapted to each other such that the counter piece can be inserted into the bore hole of the nut.
